(19) United States
(12) Patent Application Publication
(10) Pub. No.: US 2026/0091650 A1
(43) Pub. Date: Apr. 2, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/225,030

(22) Filed: Jun. 2, 2025

(30) Foreign Application Priority Data
Sep. 27, 2024 (JP) 2024-169242

(51) Int. Cl. B60H 3/02; B60H 3/06

(52) U.S. Cl. CPC B60H 3/02; B60H 3/06; B60H 2003/0691

(57) ABSTRACT

A vehicle air conditioning system includes: at least one humidity controlling device configured to adsorb and desorb moisture; an air conditioning duct having the humidity controlling device provided therein and allowing air from a vehicle interior or a vehicle exterior to flow therethrough, the air conditioning duct having a first flow path for allowing the air to flow into the vehicle interior on a downstream side of the humidity controlling device and a second flow path for discharging the air to the vehicle exterior; a valve configured to switch the flow of the air between the first flow path and the second flow path; a ventilation fan configured to adjust a flow rate of the air flowing through the air conditioning duct; and a control unit configured to control the humidity controlling device, the valve and the ventilation fan.

### CROSS REFERENCE TO RELATED APPLICATIONS

This application claims the benefit of priority to Japanese Patent Application No 2024-169242 filed on Sep. 27, 2024 with the Japanese Patent Office, the entire contents of which are incorporated herein by reference in its entirety.

### FIELD OF THE INVENTION

The present disclosure relates to a vehicle air conditioning system.

### BACKGROUND OF THE INVENTION

In various types of vehicles such as automobiles, there are increasing requirements for improvement of vehicle interior environment. Specific requirements illustrate reduction of an amount of CO₂ in a vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, a vehicle purifying system (vehicle air conditioning system) is proposed, which includes: a heater element (humidity controlling device) including a honeycomb structure having an outer peripheral wall and partition walls provided on an inner side of the outer peripheral wall, the partition walls defining a plurality of cells each extending from one end face to other end face of the honeycomb structure to form a flow path, at least the partition wall being made of a material having a PTC property; a pair of electrodes comprising a first electrode provided on the one end face and a second electrode provided on the other end face; and a functional material-containing layer provided on a surface of each partition wall; as well as an inlet pipe communicating a vehicle interior with an inlet end face of the heater element; and an outflow pipe having a first path that communicates an outlet end face of the heater element with the vehicle interior, wherein the outflow pipe has a first path that communicates an outlet end face of the heater element with the vehicle interior and a second path that communicates the outlet end face of the heater element with a vehicle exterior, and wherein the system includes a switching valve configured to switch an air flow circulating through the outflow pipe between the first path and the second path.

When executing a regeneration mode of a humidity controlling device (a process for releasing moisture and the like from a functional material-containing layer), the vehicle air conditioning system described in Patent Literature 1 applies a voltage to a pair of electrodes and heats the heater element to release moisture and the like, and then the air containing the released moisture and the like is discharged through a second path in the outflow pipe to the vehicle exterior. At this time, condensation may be generated on a downstream side of the humidity controlling device (particularly in the outflow pipe between the humidity controlling device and a valve for switching between the first flow path and the second flow path). The condensation generated in the outflow pipe may enter the vehicle interior via the first flow path when executing a moisture adsorption mode (a process for adsorbing moisture and the like by the functional material-containing layer) of the humidity controlling device. As a result, water droplets entering the vehicle interior are likely to cause fogging on the wind pane.

This disclosure was made to solve the problems as described above. An object of this disclosure is to provide a vehicle air conditioning system that can suppress the generation of condensation when executing a regeneration mode of a humidity controlling device and can suppress the intrusion of water droplets into a vehicle interior when executing a moisture adsorption mode of the humidity controlling device.

### PRIOR ART

### Patent Literature

[Patent Literature 1] WO 2023/074202 A1

### SUMMARY OF THE INVENTION

As results of intensive studies on vehicle air conditioning systems including humidity controlling devices, the inventor has found that the above problems can be solved by controlling a ventilation fan to adjust a flow rate of air so that a temperature Ta on an inner surface of an air conditioning duct in a region between the humidity controlling device and a valve is higher than a dew point temperature Tb when a regeneration mode of the humidity controlling device is executed, and thus completed this one or more embodiments of the disclosure. In other words, the embodiments are exemplified as follows:

<1> A vehicle air conditioning system, comprising:
at least one humidity controlling device configured to adsorb and desorb moisture;
an air conditioning duct having the humidity controlling device provided therein and allowing air from a vehicle interior or a vehicle exterior to flow therethrough, the air conditioning duct having a first flow path for allowing the air to flow into the vehicle interior on a downstream side of the humidity controlling device and a second flow path for discharging the air to the vehicle exterior;
a valve configured to switch the flow of the air between the first flow path and the second flow path;
a ventilation fan configured to adjust a flow rate of the air flowing through the air conditioning duct; and
a control unit configured to control the humidity controlling device, the valve and the ventilation fan,
   wherein, when executing a regeneration mode in which the valve is switched so that the air flows into the second flow path to desorb the moisture from the humidity controlling device, the control unit controls the ventilation fan so that, in a region in the air conditioning duct between the humidity controlling device and the valve, a temperature Ta on an inner surface of the air conditioning duct is higher than a dew point temperature Tb, to adjust a flow rate of the air.
   <2> The vehicle air conditioning system according to <1>, which may include a thermometer for measuring the temperature Ta on the inner surface of the air conditioning duct, and a dew point meter for measuring the dew point temperature Tb.
   <3> The vehicle air conditioning system according to <1> or <2>, wherein the temperature Ta on the inner surface of the air conditioning duct may be calculated by the following equation (1):

$$Ta = Tp - \frac{Tp - Tc}{Hci \times ( \frac{1}{Hco} + \frac{1}{Kg} + \frac{1}{Hci} )} \qquad ( 1 )$$

in which Tp is a temperature of the air in the air conditioning duct between the humidity controlling device and the valve [° C.], Tc is a temperature of the air in the vehicle interior [° C.], Hci is a heat transfer coefficient of the air in the air conditioning duct between the humidity controlling device and the valve [W/m²K], Hco is a heat transfer coefficient of the air outside the air conditioning duct between the humidity controlling device and the valve [W/m²K], and Kg is a heat transfer coefficient of the air conditioning duct [W/m²K].
<4> The vehicle air conditioning system according to <1> or <2>, wherein the temperature Ta on the inner surface of the air conditioning duct may be calculated by the following equation (2):

$$Ta = Tp - \frac{Tp + 10}{Hci \times ( \frac{1}{Hco} + \frac{1}{Kg} + \frac{1}{Hci} )} \qquad ( 2 )$$

in which Tp is a temperature of the air in the air conditioning duct between the humidity controlling device and the valve [° C.], Hci is a heat transfer coefficient of the air in the air conditioning duct between the humidity controlling device and the valve [W/m²K], Hco is a heat transfer coefficient of the air outside the air conditioning duct between the humidity controlling device and the valve [W/m²K], and Kg is a heat transfer coefficient of the air conditioning duct [W/m²K].

<5> The vehicle air conditioning system according to <3> or <4>, wherein the Tp may be calculated based on a relationship between the Tp and a flow rate of the air flowing into the humidity controlling device when the regeneration mode is executed, as determined beforehand.

<6> The vehicle air conditioning system according to <3>, wherein the Tc may be measured by a thermometer provided in the vehicle interior.

<7> The vehicle air conditioning system according to any one of <3> to <6>, wherein the Hci may be calculated by the following equation (3):

$$Hci = 7.1 \times {U}_{A}^{0.78} \qquad ( 3 )$$

in which U_{A} is a flow velocity of the air flowing into the humidity controlling device during the execution of the regeneration mode [m/s].

<8> The vehicle air conditioning system according to any one of <3> to <7>, wherein the Hco may be calculated by the following equation (4):

$$Hco = 5.57 + 3.94 {U}_{B} \qquad ( 4 )$$

in which U_{B} is a flow velocity of the air to which the air conditioning duct between the humidity controlling device and the valve is exposed [m/s].

<9> The vehicle air conditioning system according to any one of <3> to <8>, wherein the dew temperature Tb may be calculated by the following equation (5):

$$Tb = \frac{273.3 \times {log}_{10} \frac{6.1078 \times Q \times 217}{( Wd + Q \times AHi ) \times ( Tp + 273.15 )}}{{log}_{10} [ \frac{( Wd + Q \times AHi ) \times ( Tp + 273.15 )}{6.1078 \times Q \times 217} ] - 7.5} \qquad ( 5 )$$

in which Wd is an amount of moisture released by the humidity controlling device [g/s], Q is a flow rate of the air flowing into the humidity controlling device [m³/s], AHi is an absolute humidity of the air flowing into the humidity controlling device [g/m³], and Tp is a temperature of the air in the air conditioning duct between the humidity controlling device and the valve [° C.].

<10> The vehicle air conditioning system according to any one of <3> to <8>, wherein the dew temperature Tb may be calculated by the following equation (6):

$$Tb = \frac{273.3 \times {log}_{10} \frac{6.1078 \times Q \times 217}{( Wd + Q \times 10 ) \times ( Tp + 273.15 )}}{{log}_{10} [ \frac{( Wd + Q \times 10 ) \times ( Tp + 273.15 )}{6.1078 \times Q \times 217} ] - 7.5} \qquad ( 6 )$$

in which Wd is an amount of moisture released by the humidity controlling device [g/s], Q is a flow rate of the air flowing into the humidity controlling device [m³/s], and Tp is a temperature of the air in the air conditioning duct between the humidity controlling device and the valve [° C.].

<11> The vehicle air conditioning system according to <9> or <10>, wherein the Wd may be calculated based on a relationship between a flow rate and an inflow time of the air flowing into the humidity controlling device, which is determined beforehand.

<12> The vehicle air conditioning system according to <9>, wherein the AHi may be measured by the hygrometer provided in the air conditioning duct on an upstream side of the humidity controlling device.

<13> The vehicle air conditioning system according to any one of <1> to <12>, wherein the humidity controlling device may include: an adsorption portion containing an adsorbent configured to adsorb the moisture at a temperature lower than or equal to a predetermined temperature and desorb the adsorbed moisture when the temperature exceeds the predetermined temperature; and a heating means or a heating structure configured to heat the adsorption portion.

<14> The vehicle air conditioning system according to <13>, wherein the humidity controlling device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer containing the adsorbent, the adsorbing layer being provided on a surface of each of the partition walls; and
a pair of electrodes provided on the first end face and the second end face of the honeycomb structure, or on the outer peripheral wall parallel to the extending direction of the cells of the honeycomb structure.

<15> The vehicle air conditioning system according to <14>, wherein at least the partition walls of the honeycomb structure may be made of a material having a PTC property.

<16> The vehicle air conditioning system according to <13>, wherein the humidity controlling device may have a flow path for the air and a flow path for a heating medium adjacent to the flow path for the air, and wherein the adsorption portion is provided in the flow path for the air.

<17> The vehicle air conditioning system according to <13>, wherein the humidity controlling device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer comprising the adsorbent, the adsorbing layer being provided on a surface of each of the partition walls; and
a heater provided on an upstream side of the honeycomb structure.

<18> The air conditioning system according to any one of <13> to <17>, wherein the adsorbent may be configured to adsorb and desrob carbon dioxide and/or volatile components, in addition to the moisture.

### BRIEF DESCRIPTION OF THE DRAWINGS

FIG. 1 is an overall schematic configuration view of a vehicle air conditioning system according to an embodiment;

FIG. 2 is a graph illustrating an example of a control method so that a temperature Ta on an inner surface of an air conditioning duct in a region in the air conditioning duct between a humidity controlling device and a valve is higher than a dew point temperature Tb, when a regeneration mode is executed;

FIG. 3A is a schematic view of a cross section of a typical humidity controlling device used in a vehicle air conditioning system according to an embodiment of the present disclosure, which is parallel to a flow path direction; and

FIG. 3B is a schematic cross-sectional view of the humidity controlling device taken along the line a-a′ in FIG. 3A.

### DETAILED DESCRIPTION OF THE INVENTION

A vehicle air conditioning system according to this disclosure includes: a humidity controlling device configured to adsorb and desorb moisture; an air conditioning duct having the humidity controlling device provided therein and allowing air from a vehicle interior or a vehicle exterior to flow therethrough, the air conditioning duct having a first flow path for allowing the air to flow into the vehicle interior on a downstream side of the humidity controlling device and a second flow path for discharging the air to the vehicle exterior; a valve configured to switch the flow of the air between the first flow path and the second flow path; a ventilation fan configured to adjust a flow rate of the air flowing through the air conditioning duct; and a control unit configured to control the humidity controlling device, the valve and the ventilation fan. When executing a regeneration mode in which the valve is switched so that the air flows into the second flow path to desorb the moisture from the humidity controlling device, the control unit controls the ventilation fan so that in a region in the air conditioning duct between the humidity controlling device and the valve, a temperature Ta on an inner surface of the air conditioning duct is higher than a dew point temperature Tb, to adjust a flow rate of the air. The vehicle air conditioning system according to this disclosure can suppress the generation of condensation in the region in the air conditioning duct between the humidity controlling device and the valve when the regeneration mode of the humidity controlling device is executed by the above configuration. This can prevent water droplets (condensation water) from entering the vehicle interior when executing the moisture adsorption mode of the humidity controlling device.

Hereinafter, embodiments of the disclosure will be specifically described with reference to the drawings. It should be understood that the disclosure is not limited to the following embodiments, and those which have appropriately added changes, improvements and the like to the following embodiments based on knowledge of a person skilled in the art without departing from the spirit of the disclosure fall within the scope of the disclosure.

The terms “upstream side” and “downstream side” as used herein are based on the flow of the air flowing through the vehicle air conditioning system.

The vehicle air conditioning system according to an embodiment can be suitably utilized for various vehicles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system according to an embodiment can be suitably used for a vehicle that has no internal combustion engine such as electric vehicles and electric rail cars.

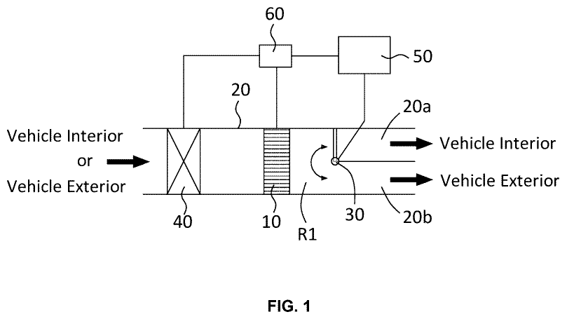

FIG. 1 is an overall schematic configuration view of a vehicle air conditioning system according to an embodiment.

As illustrated in FIG. 1, a vehicle air conditioning system according to an embodiment includes: a humidity controlling device 10; an air conditioning duct 20; a valve 30; a ventilation fan 40; and a control unit 50. Further, the vehicle air conditioning system can further include a power source 60.

The humidity controlling device 10 can be configured to adsorb and desorb moisture.

The air conditioning duct 20 has the humidity controlling device 10 provided therein and allowing air from a vehicle interior or a vehicle exterior to flow therethrough, and the air conditioning duct 20 also has a first flow path 20a for allowing the air to flow into the vehicle interior on a downstream side of the humidity controlling device 10 and a second flow path 20b for discharging the air to the vehicle exterior.

The valve 30 may be configured to switch the flow of the air between the first flow path 20a and the second flow path 20b.

The ventilation fan 40 can be configured to adjust a flow rate of the air flowing through the air conditioning duct 20.

The control unit 50 can also control the humidity controlling device 10, the valve 30 and the ventilation fan 40.

In the vehicle air conditioning system having the above structure, when the air from the vehicle interior or vehicle exterior flows through the air conditioning duct 20, the adsorption or desorption of the moisture (water vapor) can be performed in the humidity controlling device 10. When the moisture is adsorbed in the humidity controlling device 10, then it should be a humidity adsorption mode that does not heat the humidity controlling device 10. In the humidity adsorption mode, the air that has reduced or removed the moisture in the humidity controlling device 10 can be allowed to flow into the vehicle interior by switching the valve 30 so that it flows into the first flow path 20a. On the other hand, when desorbing the moisture in the humidity controlling device 10, then it should be a regeneration mode that heats the humidity controlling device 10. In the regeneration mode, the air containing the moisture desorbed from the humidity controlling device 10 can be discharged to the vehicle exterior by switching the valve 30 so that it flows into the second flow path 20b.

When executing the regeneration mode in which the valve is switched so that the air flows into the second flow path 20b to desorb the moisture from the humidity controlling device 10, the control unit 50 controls the ventilation fan 40 so that in a region R1 in the air conditioning duct between the humidity controlling device 10 and the valve 30, a temperature Ta on an inner surface of the air conditioning duct 20 is higher than a dew point temperature Tb, to adjust a flow rate of the air. By adjusting the flow rate of the air in this way, the generation of condensation can be suppressed in the region R1. Therefore, water droplets (condensation water) can be prevented from entering the vehicle interior when the humidity controlling device is switched from the regeneration mode to the moisture adsorption mode. Specifically, when the dew point temperature Tb in the region R1 is close to the temperature Ta on the inner surface of the air conditioning duct 20, the rotational speed of the ventilation fan 40 is increased to increase the flow rate of the air. Since the dew point temperature Tb has a greater effect on changes in the flow rate of the air than the temperature Ta on the inner surface of the air conditioning duct 20, increasing the flow rate of the air causes the dew point temperature Tb to decrease more significantly than the temperature Ta on the inner surface of the air conditioning duct 20. Specifically, by increasing the flow rate of the air, the proportion of the moisture in the air in the region R1 is reduced, so that the dew point temperature Tb can be maintained at a level lower than the temperature Ta on the inner surface of the air conditioning duct 20.

The vehicle air conditioning system according to an embodiment can further include a thermometer for measuring the temperature Ta on the inner surface of the air conditioning duct 20 and a dew point meter for measuring the dew point temperature Tb in the region R1. With this configuration, the temperature Ta on the inner surface of the air conditioning duct 20 and the dew point temperature Tb in the region R1 can be measured. The thermometer and the dew point meter are connected to the control unit 50.

The thermometer and the dew point meter are not particularly limited, and any of commercially available thermometers and dew point meters can be used.

Instead of arranging the thermometer and the dew point meter to measure the temperature Ta on the inner surface of the air conditioning duct 20 and dew point temperature Tb in the region R1, the vehicle air conditioning system according to an embodiment may calculate the temperature Ta on the inner surface of the air conditioning duct 20 and dew point temperature Tb in the region R1 using predetermined equations. Hereinafter, methods for calculating the temperature Ta on the inner surface of the air conditioning duct 20 and the dew point temperature Tb in the region R1 will be described.

The temperature Ta on the inner surface of the air conditioning duct 20 in the region R1 can be calculated by the following equation (1).

$$Ta = Tp - \frac{Tp - Tc}{Hci \times ( \frac{1}{Hco} + \frac{1}{Kg} + \frac{1}{Hci} )} \qquad ( 1 )$$

In the equation (1), Tp is the temperature of the air in the air conditioning duct 20 (region R1) between the humidity controlling device 10 and the valve 30 [° C.], Tc is the temperature of the air in the vehicle interior [° C.], Hci is a heat transfer coefficient of the air in the air conditioning duct 20 (region R1) between the humidity controlling device 10 and the valve 30 [W/m²K], Hco is a heat transfer coefficient of the air outside the air conditioning duct 20 between the humidity controlling device 10 and the valve 30 [W/m²K], and Kg is a heat transfer coefficient of the air conditioning duct 20 [W/m²K].

The Tc in the equation (1) may be a fixed value that assumes in advance the most severe conditions under which the condensation is likely to occur. Specifically, since the condensation tends to occur under low temperature and high humidity conditions, the temperature Ta on the inner surface of the air conditioning duct 20 in the region R1 may be calculated based on the temperature of the air in the vehicle interior at −10 [° C.]. In this case, the temperature Ta on the inner surface of the air conditioning duct 20 can be calculated by the following equation (2).

$$Ta = Tp - \frac{Tp + 10}{Hci \times ( \frac{1}{Hco} + \frac{1}{Kg} + \frac{1}{Hci} )} \qquad ( 2 )$$

In the equation (2), Tp is the temperature of the air in the air conditioning duct 20 (region R1) between the humidity controlling device 10 and the valve 30 [° C.], Hci is a heat transfer coefficient of the air in the air conditioning duct 20 (region R1) between the humidity controlling device 10 and the valve 30 [W/m²K], Hco is a heat transfer coefficient of the air outside the air conditioning duct 20 between the humidity controlling device 10 and the valve 30 [W/m²K], and Kg is a heat transfer coefficient of the air conditioning duct 20 [W/m²K].

In the equations (1) and (2), the Tp may be measured by placing the thermometer in the air conditioning duct 20 between the humidity controlling device 10 and the valve 30 (region R1), but it is preferable to calculate it based on a previously determined relationship between the Tp and the flow rate of the air flowing into the humidity controlling device 10 when the regeneration mode is executed. In other words, it is preferable to determine in advance the relationship between the flow rate of the air flowing into the humidity controlling device 10 and Tp when the regeneration mode is executed, and to calculate Tp from the flow rate of the air flowing into the humidity controlling device 10 based on that relationship. Such a calculation of Tp leads to simplification of the vehicle air conditioning system because there is no need to place the thermometer in the air conditioning duct 20 (region R1) between the humidity controlling device 10 and the valve 30.

In the equation (1), the Tc can be measured by a thermometer placed in the vehicle interior. Since the thermometer is commonly installed in the vehicle interior, there is no need to place a thermometer separately. In other words, the value of the temperature of the air in the vehicle interior measured by this commonly installed thermometer can be used as Tc.

In the equations (1) and (2), the Hci varies with the flow velocity of the air flowing in the air conditioning duct 20 (region R1) between the humidity controlling device 10 and the valve 30, and can be calculated by the following equation (3).

$$Hci = 7.1 \times {U}_{A}^{0.78} \qquad ( 3 )$$

In the equation (3), the U_{A} is the flow velocity of the air flowing into the humidity controlling device 10 during the execution of the regeneration mode [m/s]. The flow velocity of the air at this time may preferably be 5 m/s or higher. The flow velocity [m/s] of the air flowing into the humidity controlling device 10 when the regeneration mode is executed can be calculated by dividing the flow rate [m³/s] of the air flowing into the humidity controlling device 10 by the flow path (cell) cross-sectional area [m²] of the humidity controlling device 10.

In the equations (1) and (2), the Hco varies with the flow velocity of the air to which the air conditioning duct 20 between the humidity controlling device 10 and the valve 30 is exposed, and can be calculated by the following equation (4).

$$Hco = 5.57 + 3.94 {U}_{B} \qquad ( 4 )$$

In the equation (4), the U_{B} is the flow velocity of the air to which the air conditioning duct 20 between the humidity controlling device 10 and the valve 30 is exposed [m/s]. The flow velocity of the air at this time may preferably be less than 5 m/s. The flow velocity [m/s] of the air to which the air conditioning duct 20 between the humidity controlling device 10 and the valve 30 is exposed can be measured by a commercially available current meter.

In the equations (1) and (2), the Kg varies with the material and thickness of the air conditioning duct 20, and it is, therefore, calculated in advance from the material and thickness of the air conditioning duct 20. Specifically, the Kg is calculated by the following equation (A):

$$Kg = 1 / ( thermal conductivity of material making up air conditioning duct [ W / mK ] / thickness of air conditioning duct [ m ] ) \qquad ( A )$$

The dew point temperature Tb in the region R1 can be calculated by the following equation (5).

$$Tb = \frac{273.3 \times {log}_{10} \frac{6.1078 \times Q \times 217}{( Wd + Q \times AHi ) \times ( Tp + 273.15 )}}{{log}_{10} [ \frac{( Wd + Q \times AHi ) \times ( Tp + 273.15 )}{6.1078 \times Q \times 217} ] - 7.5} \qquad ( 5 )$$

In the equation (5), the Wd is an amount of moisture released by the humidity controlling device 10 [g/s], Q is a flow rate of the air flowing into the humidity controlling device 10 [m³/s], AHi is an absolute humidity of the air flowing into the humidity controlling device 10 [g/m³], and Tp is a temperature of the air in the air conditioning duct 20 (region R1) between the humidity controlling device 10 and the valve 30 [° C.].

The AHi in the equation (5) may be a fixed value that assumes in advance the most severe conditions under which the condensation is likely to occur. Specifically, since the condensation tends to occur under low temperature and high humidity conditions, the dew point temperature Tb in the region R1 may be calculated based on when the absolute humidity of the air flowing into the humidity controlling device 10 is 10 [g/m³]. In this case, the dew point temperature Tb in the region R1 can be calculated by the following equation (6).

$$Tb = \frac{273.3 \times {log}_{10} \frac{6.1078 \times Q \times 217}{( Wd + Q \times 10 ) \times ( Tp + 273.15 )}}{{log}_{10} [ \frac{( Wd + Q \times 10 ) \times ( Tp + 273.15 )}{6.1078 \times Q \times 217} ] - 7.5} \qquad ( 6 )$$

In the equation (6), the Wd is an amount of moisture released by the humidity controlling device 10 [g/s], Q is a flow rate of the air flowing into the humidity controlling device 10 [m³/s], and Tp is a temperature of the air in the air conditioning duct 20 (region R1) between the humidity controlling device 10 and the valve 30 [° C.].

In the equations (5) and (6), the Wd may be calculated from the difference in humidity obtained by placing hygrometers upstream and downstream of the humidity controlling device 10 and measuring the humidity, but it is preferable to calculate it based on the relationship between the flow rate and the inflow time of the air flowing into the humidity controlling device 10, which is determined beforehand. In other words, it is preferable to determine in advance the relationship between Wd and the flow rate and inflow time of the air flowing into the humidity controlling device 10 when the regeneration mode is executed, and to calculate Wd from the flow rate and inflow time of the air flowing into the humidity controlling device 10 based on that relationship. Such a calculation leads to simplification of the vehicle air conditioning system because it eliminates the need to place hygrometers upstream and downstream of the humidity controlling device 10.

In the equation (5), the AHi can be measured by a hygrometer located in the air conditioning duct 20 upstream of the humidity controlling device 10. The hygrometer is connected to the control unit 50.

The hygrometer is not particularly limited, and any of commercially available hygrometers can be used.

In the equations (5) and (6), the Q can be adjusted by controlling the rotational speed of the ventilation fan 40. Also, the Tp can be determined in the same manner as Tp in the equations (1) and (2).

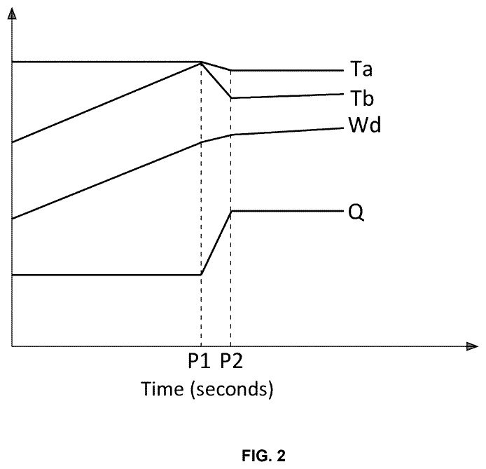

Here, FIG. 2 illustrates a graph showing an example of a control method so that the temperature Ta on the inner surface of the air conditioning duct 20 in the region R1 in the air conditioning duct 20 between the humidity controlling device 10 and a valve 30 is higher than the dew point temperature Tb, when the regeneration mode is executed.

As illustrated in FIG. 2, when the regeneration mode is executed, the dew point temperature in the region R1 increases as the moisture is desorbed from the humidity controlling device 10, so that the dew point temperature Tb becomes close to the temperature Ta on the inner surface of the air conditioning duct 20 (time 0 to P1). If the regeneration mode is executed in this state, the dew point temperature Tb will be higher than the temperature Ta on the inner surface of the air conditioning duct 20, so that the condensation will easily occur in the region R1. Therefore, by increasing the flow rate Q of the air flowing into the humidity controlling device 10, the moisture content of the air in the region R1 is reduced and the dew point temperature Tb is lowered (time P1 to P2). At this time, the temperature Ta on the inner surface of the air conditioning duct 20 also decreases slightly, but the rate of decrease is smaller than the rate of decrease of the dew point temperature Tb. The amount of the moisture released by the humidity controlling device 10, Wd, also increases with an increase in the flow rate Q of the air. When the flow rate Q of the air is increased to a predetermined value and maintained, the increase in the dew point temperature Tb decreases because the variation of the amount of moisture released, Wd, by the humidity controlling device 10, is reduced, so that the dew point temperature Tb can be maintained at a level lower than the temperature Ta on the inner surface of the air conditioning duct 20 (after time P2).

The flow rate Q of the air flowing into the humidity controlling device 10 as described above affects the temperature Ta on the inner surface of the air conditioning duct 20 and the dew point temperature Tb when the regeneration mode is executed. Specifically, as the flow rate Q of the air flowing into the humidity controlling device 10 increases, the temperature Ta on the inner surface of the air conditioning duct 20 and the dew point temperature Tb decrease when the regeneration mode is executed. In particular, when the flow rate Q of the air flowing into the humidity controlling device 10 increases, the dew point temperature Tb decreases at a significantly lower level than the temperature Ta on the inner surface of the air conditioning duct 20. Therefore, by controlling the flow rate Q of the air flowing into the humidity controlling device 10, the temperature Ta on the inner surface of the air conditioning duct 20 can be controlled to be higher than the dew point temperature Tb.

The flow rate Q of the air flowing into the humidity controlling device 10 is not particularly limited and can be adjusted according to the type of humidity controlling device 10 used, but it may preferably be 0.00050 [m³/s] or more, and more preferably 0.00083 [m³/s] or more.

Each component of the vehicle air conditioning system will be described below in detail.

### (1. Humidity Controlling Device 10)

The humidity controlling device 10 is not particularly limited as long as it can adsorb and desorb the moisture, but it preferably includes: an adsorption portion containing an adsorbent configured to adsorb the moisture at a temperature lower than or equal to a predetermined temperature and desorb the adsorbed moisture when the temperature exceeds the predetermined temperature; and a heating means or a heating structure configured to heat the adsorption portion. The humidity controlling device 10 having these features can easily achieve adsorption and desorption of moisture.

Also, the number of humidity controlling devices 10 provided in the air conditioning duct 20 may be one or more than one. When more than one humidity controlling devices 10 are provided, they may be arranged in parallel to or in series with the flow of the air flowing through the air conditioning duct 20.

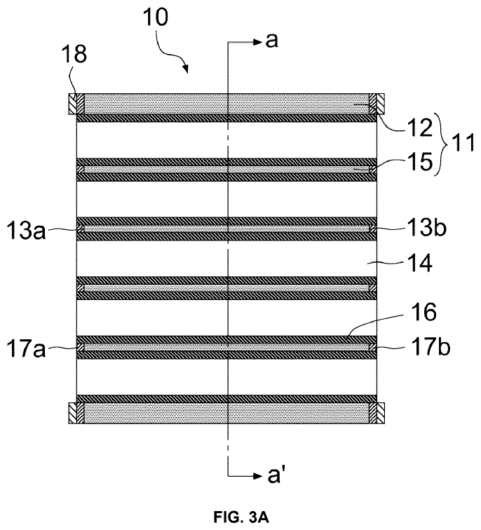

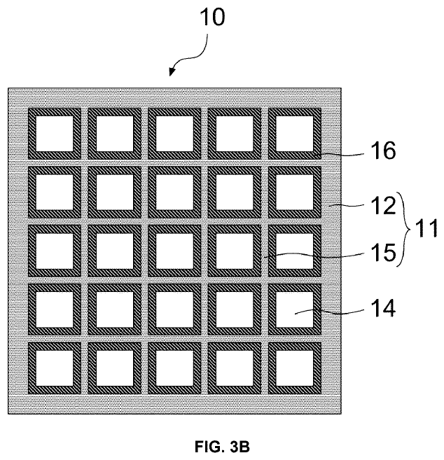

FIG. 3A is a schematic view of a cross section of a typical humidity controlling device used in a vehicle air conditioning system according to an embodiment of the present disclosure, which is parallel to a flow path direction; and FIG. 3B is a schematic cross-sectional view of the humidity controlling device in FIG. 3A taken along the line a-a′.

The humidity controlling device 10 as illustrated in FIGS. 3A and 3B includes: a honeycomb structure 11 having an outer peripheral wall 12 and partition walls 15 provided on an inner side of the outer peripheral wall 12, the partition walls 15 defining a plurality of cells 14 each extending from a first end face 13a to a second end face 13b of the honeycomb structure 11 to form a flow path for air; an adsorbing layer 16 containing an adsorbent, the adsorbing layer 16 being provided on a surface of each of the partition walls 15; and a pair of electrodes 17a, 17b provided on the first end face 13a and the second end face 13b of the honeycomb structure 11. Although not illustrated, the pair of electrodes 17a, 17b may be provided on the outer peripheral wall 12 parallel to the extending direction of the cells 14 of the honeycomb structure 11. Also, Terminals 18 may be connected to the pair of electrodes 17a, 17b, respectively.

### (1-1. Honeycomb Structure 11)

The shape of the honeycomb structure 11 is not particularly limited. For example, an outer shape of a cross section of the honeycomb structure 11 orthogonal to the flow path direction (extending direction of the cells 14) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 13a and second end face 13b) have the same shape as the cross section. Also, when the cross section and the end faces are polygonal, the corners may be chamfered.

The shape of each cell 14 is not particularly limited, but it may be polygonal such as quadrangular, pentagonal, hexagonal, heptagonal, and octagonal, circular, or oval in the cross section of the honeycomb structure 11 orthogonal to the flow path direction. These shapes may be alone or in combination of two or more. Moreover, among these shapes, the quadrangle or the hexagon is preferable. By providing the cells 14 having such a shape, it is possible to reduce the pressure loss when the air flows.

The honeycomb structure 11 may be a honeycomb joined body that includes a plurality of honeycomb segments and joining layers that join outer peripheral side surfaces of the plurality of honeycomb segments together. The use of the honeycomb joined body can increase the total cross-sectional area of the cells 14, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 12 and the partition walls 15. In addition to the role of joining the honeycomb segments to each other, the joining material can also be used as an outer peripheral coating material after joining the honeycomb segments.

From the viewpoints of ensuring the strength of the honeycomb structure 11, reducing a pressure loss when the air passes through the cells 14, ensuring the amount of the adsorbent supported, and ensuring the contact area with the air flowing inside the cells 14, it is desirable to suitably combine a thickness of the partition wall 15, a cell density, and a cell pitch (or an opening ratio of the cells 14).

As used herein, the cell density refers to a value obtained by dividing a number of cells by an area of one end face (first end face 13a or second end face 13b) of the honeycomb structure 11 (the total area of the partition walls 15 and the cells 14 excluding the outer peripheral wall 12).

As used herein, the cell pitch refers to a value obtained by the following calculation. First, the area of one end face (first end face 13a or second end face 13b) of the honeycomb structure 11 (the total area of the partition walls 15 and the cells 14 excluding the outer peripheral wall 12) is divided by the number of the cells to calculate an area per a cell. A square root of the area per a cell is then calculated, and this is determined to be the cell pitch.

As used herein, the opening ratio of the cells 14 refers a value obtained by dividing the total area of the cells 14 defined by the partition walls 15 by the area of one end face (first end face 13a or second end face 13b) (the total area of the partition walls 15 and the cells 14 excluding the outer peripheral wall 12) in the cross section orthogonal to the flow path direction of the honeycomb structure 11. It should be noted that when calculating the opening ratio of the cells 14, the pair of electrodes 17a, 17b, and the adsorbing layer 16 are not taken into account.

In an embodiment that is advantageous from the viewpoint of supporting a sufficient amount of functional material, the thickness of the partition walls 15 is 0.300 mm or less, the cell density is 100 cells/cm² or less, and the cell pitch is 1.0 mm or more. In a preferred embodiment, the thickness of the partition walls 15 is 0.200 mm or less, the cell density is 70 cells/cm² or less, and the cell pitch is 1.2 mm or more. In a more preferred embodiment, the thickness of the partition walls 15 is 0.130 mm or less, the cell density is 65 cells/cm² or less, and the cell pitch is 1.3 mm or more.

From the viewpoints of ensuring the strength of the honeycomb structure 11 and maintaining lower electrical resistance, the lower limit of the thickness of the partition wall 15 is preferably 0.010 mm or more, more preferably 0.020 mm or more, and even more preferably 0.030 mm or more.

From the viewpoints of ensuring the strength of the honeycomb structure 11, maintaining lower electrical resistance, and increasing a surface area to facilitate reaction, adsorption, and desorption, the lower limit of the cell density is 30 cells/cm² or more, and preferably 35 cells/cm² or more, and even more preferably 40 cells/cm² or more.

From the viewpoints of ensuring the strength of the honeycomb structure 11, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 15 is 0.08 to 0.36 mm, the cell density is 2.54 to 140 cells/cm², and the opening ratio of the cells 14 is 0.70 or more. In a preferred embodiment, the thickness of the partition walls 15 is 0.09 to 0.35 mm, the cell density is 15 to 100 cells/cm², and the opening ratio of the cells 14 is 0.80 or more. In a more preferred embodiment, the thickness of the partition walls 15 is 0.14 to 0.30 mm, the cell density is 20 to 90 cells/cm², and the opening ratio of the cells 14 is 0.85 or more.

From the viewpoint of ensuring the strength of the honeycomb structure 11, the upper limit of the opening ratio of the cells 14 is preferably 0.94 or less, more preferably 0.92 or less, and even more preferably 0.90 or less.

Although the thickness of the outer peripheral wall 12 is not particularly limited, it is preferably determined based on the following considerations. First, from the viewpoint of reinforcing the honeycomb structure 11, the thickness of the outer peripheral wall 12 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 12 is preferably 1.0 mm or less, more preferably 0.5 mm, even more preferably 0.4 mm or less, and still more preferably 0.3 mm or less.

As used herein, the thickness of the outer peripheral wall 12 refers to a length, in a normal line direction of a side surface of the honeycomb structure 11, from a boundary between the outer peripheral wall 12 and the outermost cell 14 or the partition wall 15 to the side surface of the honeycomb structure 11 in the cross section orthogonal to the flow path direction of the honeycomb structure 11.

The length of the honeycomb structure 11 in the flow path direction and the cross-sectional area orthogonal to the flow path direction may be adjusted according to the required size of the humidity controlling device 10, and are not particularly limited. For example, when used in a compact humidity controlling device 10 while ensuring a predetermined function, the honeycomb structure 11 can have a length of 2 to 20 mm in the flow path direction and a cross-sectional area of 10 cm² or more orthogonal to the flow path direction. Although the upper limit of the cross-sectional area orthogonal to the flow path direction of the honeycomb structure 11 is not particularly limited, it is, for example, 300 cm² or less

The partition walls 15 forming the honeycomb structure 11 are preferably made of a material that can be heated by electric conduction, specifically made of a material having a PTC property. Further, the outer peripheral wall 12 may also be made of a material having a PTC property, as with the partition walls 15, as needed. By such a configuration, the adsorbing layer 16 can be directly heated by heat transfer from the heat-generating partition walls 15 (and optionally the outer peripheral wall 12). Further, the material having the PTC property has characteristics such that when the temperature increases to exceed the Curie point, the resistance value is sharply increased, making it difficult for electricity to flow. Therefore, when the temperature of the partition walls 15 (and the outer peripheral wall 12 if necessary) becomes high, the current flowing through them is limited, thereby suppressing excessive heat generation of the honeycomb structure 11. Therefore, it is possible to suppress thermal deterioration of the adsorbing layer 16 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271: 2008.

From the viewpoints that can be heated by electric conduction and has the PTC property, the outer peripheral wall 12 and the partition walls 15 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 12 and the partition walls 15 are substantially free of lead (Pb). Specifically, the outer peripheral wall 12 and the partition walls 15 preferably have a Pb content of 0.01% by mass or less, and more preferably 0.001% by mass or less, and still more preferably 0% by mass. The lower Pb content can allow the air heated by contact with the heat-generating partition walls 15 or the like to be safely applied to organisms such as humans, for example. In the outer peripheral wall 12 and the partition walls 15, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 12 and the partition walls 15 is preferably in a temperature range where the resistance value is twice or more the resistance at room temperature (25° C.). If the Curie point is in such a temperature range, the current flowing through the humidity controlling device 10 will be limited when the temperature of the humidity controlling device 10 becomes high, so that any excessive heat generation of the humidity controlling device 30 will be efficiently suppressed. Therefore, thermal deterioration of the adsorbing layer 16 caused by excessive heat generation can be suppressed.

In terms of efficiently heating the adsorbing layer 16, the material making up the outer peripheral wall 12 and the partition walls 15 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 12 and the partition walls 15 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (1-2. Adsorbing Layer 16)

The adsorbing layer 16 contains an adsorbent.

The adsorbing layer 16 can be provided on the surfaces of the partition walls 15 (in the case of the outermost cells 14, the partition walls 15 that define the outermost cells 14 and the outer peripheral wall 12). By thus providing the adsorbing layer 16, the moisture is easily adsorbed during the moisture adsorption mode, and the adsorbing layer 16 can be easily heated during the regeneration mode, so that the moisture is easily separated.

The adsorbent contained in the adsorbing layer 16 is capable of adsorbing and separating the moisture. Also, the adsorbent can preferably adsorb and desorb carbon dioxide and/or volatile components, in addition to the moisture. By using such an adsorbent, it is possible to obtain the moisture adsorbing effects by the humidity controlling device 10 as well as purifying effects.

The adsorbent contained in the adsorbing layer 16 preferably has a function that can adsorb the moisture and the like at −20 to 60° C. and separate them at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 16 can further contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 16 may be determined according to the size of the cells 14, and is not particularly limited. For example, from the viewpoint of ensuring sufficient contact with air, the thickness of the adsorbing layer 16 is preferably 20 μm or more, more preferably 25 μm or more, and even more preferably 30 μm or more. On the other hand, from the viewpoint of suppressing separation of the adsorbing layer 16 from the partition walls 15 and the outer peripheral wall 12, the thickness of the adsorbing layer 16 is preferably 400 μm or less, more preferably 380 μm or less, and even more preferably 350 μm or less.

The thickness of the adsorbing layer 16 is measured using the following procedure. Any cross section of the honeycomb structure 11 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 11. The thickness of each adsorbing layer 16 visually recognized from the cross-sectional image is calculated by dividing the cross-sectional area by the length of the cells 14 in the flow path direction. This calculation is performed for all the adsorbing layers 16 visually recognized from the cross-sectional image, and an average value thereof is determined to be the thickness of the adsorbing layer 16.

From the viewpoint of exerting a desired function in the humidity controlling device 10, an amount of the adsorbing layer 16 is preferably 50 to 500 g/L, more preferably 100 to 400 g/L, and even more preferably 150 to 350 g/L, based on the volume of the honeycomb structure 11. It should be noted that the volume of the honeycomb structure 11 is a value determined by the external dimensions of the honeycomb structure 11.

### (1-3. Pair of Electrodes 17a, 17b)

A pair of electrodes 17a, 17b may be provided on the first end face 13a and the second end face 13b of the honeycomb structure 11, respectively, as illustrated in FIG. 3A, although the positions of the electrodes 17a, 17b are not limited thereto. Also, the pair of electrodes 17a, 17b may be provided on the outer peripheral wall 12 parallel to the extending direction of the cells 14 of the honeycomb structure 11.

Applying a voltage between the pair of electrodes 17a, 17b allows the honeycomb structure 11 to generate heat by Joule heat.

The pair of electrodes 17a, 17b may employ, for example, a metal or alloy containing at least one selected from Cu, Ag, Al, Ni and Si, although not particularly limited thereto. It is also possible to use an ohmic electrode capable of ohmic contact with the outer peripheral wall 12 and/or the partition walls 15 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 17a, 17b may have a single-layer structure, or may have a laminated structure of two or more layers. When the pair of electrodes 17a, 17b have the laminated structure of two or more layers, the materials of the respective layers may be of the same type or of different types.

The thickness of the pair of electrodes 17a, 17b may be appropriately set according to the method for forming the pair of electrodes 17a, 17b. The method for forming the pair of electrodes 17a, 17b includes metal deposition methods such as sputtering, vapor deposition, electrolytic deposition, and chemical deposition. Alternatively, the pair of electrodes 17a, 17b can be formed by applying an electrode paste and then baking it, or by thermal spraying. Furthermore, the pair of electrodes 17a, 17b may be formed by joining metal sheets or alloy sheets.

Each of the thicknesses of the pair of electrodes 17a, 17b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (1-4. Terminal 18)

The terminals 18 are connected to the pair of electrodes 17a, 17b, and provided on at least part of the pair of electrodes 17a, 17b. The provision of the terminals 18 facilitates connection to an external power supply. The terminals 18 are connected to a conductor connected to the external power supply.

The terminals 18 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 18 are not particularly limited. For example, as illustrated in FIG. 3A, the terminals 18 can be provided on the whole of the pair of electrodes 17a, 17b on the outer peripheral wall 12. Further, the terminals 18 may be provided on a part of the pair of electrodes 17a, 17b on the outer peripheral wall 12, or may be provided so as to extend toward an outer side than the outer edge of each of the pair of electrodes 17a, 17b on the outer peripheral wall 12. Further, the terminals 18 may be provided on a part of the pair of electrodes 17a, 17b on the partition walls 15, or may be provided so as to block a part of the cells 14.

Furthermore, the thickness of the terminal 18 is not particularly limited, but it is, for example, 0.01 to 10 mm, typically 0.05 to 5 mm.

The method of connecting the terminals 18 to the pair of electrodes 17a, 17b is not particularly limited as long as they are electrically connected. For example, they can be connected by diffusion bonding, a mechanical pressing mechanism, welding, or the like.

### (1-5. Method for Producing Humidity Controlling Device 10)

The method for producing the humidity controlling device 10 according to the embodiment of the present disclosure is not particularly limited, and it can be performed according to a known method. Hereinafter, the method for producing the humidity controlling device 10 according to an embodiment of the present disclosure will be illustratively described.

A method for producing the honeycomb structure 11 forming the humidity controlling device 10 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 11 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 11 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 11.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. The maintaining at 900 to 950° C. for 0.5 to 5 hours can lead to sufficient decomposition of BaCO₃, so that the honeycomb structure 11 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 17a, 17b is formed on the honeycomb structure 11 thus obtained. The pair of electrodes 17a, 17b can be formed by metal deposition methods such as sputtering, vapor deposition, electrolytic deposition, and chemical deposition. Further, the pair of electrodes 17a, 17b can also be formed by applying an electrode paste and then baking it. Furthermore, the pair of electrodes 17a, 17b can also be formed by thermal spraying. The pair of electrodes 17a, 17b may be composed of a single layer, but may also be composed of a plurality of electrode layers having different compositions. A typical method for forming the pair of electrodes 17a, 17b will be described below.

First, an electrode slurry containing an electrode material, an organic binder, and a dispersion medium is prepared, and the first end face 13a or the second end face 13b of the honeycomb structure 11 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 11 is removed by blowing and wiping. The slurry can be then dried to form the pair of electrodes 17a, 17b on the first end face 13a or the second end face 13b of the honeycomb structure 11. The drying can be performed while heating the honeycomb structure 11 to a temperature of about 120 to 600° C., for example. Although a series of steps of coating, slurry removal, and drying may be performed only once, the steps can be repeated multiple times to provide the pair of electrodes 17a, 17b having desired thicknesses.

The terminals 18 are then provided at predetermined positions of the pair of electrodes 17a, 17b, and the pair of electrodes 17a, 17b and the terminals 18 are connected to each other. As a method of connecting the pair of electrodes 17a, 17b to the terminals 18, the method described above can be used.

It should be noted that the terminals 18 may be placed after forming an adsorbing layer 16 described below.

The adsorbing layer 16 is then formed on the surfaces of the partition walls 15 and the like of the honeycomb structure 11.

Although the method for forming the adsorbing layer 16 is not particularly limited, it can be formed, for example, by the following steps. The honeycomb structure 11 is immersed in a slurry containing an adsorbent, a binder, and a dispersion medium for a predetermined period of time, and an excess slurry on the end faces and the outer periphery of the honeycomb structure 11 is removed by blowing and wiping. The binder may be an organic binder or an inorganic binder, or a combination thereof. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 16 on the surfaces of the partition walls 15 and the like. The drying can be performed while heating the honeycomb structure 11 to a temperature of about 120 to 600° C., for example. Although a series of steps of immersion, slurry removal, and drying may be performed only once, the steps can be repeated multiple times to provide the adsorbing layer 16 having the desired thickness on the surfaces of the partition walls 15 and the like.

### (1-6. Humidity Controlling Device 10)

The humidity controlling device 10 has a flow path for the air and a flow path for a heating medium adjacent to the flow path for the air, and the adsorption portion is provided in the flow path for the air. The humidity controlling device 10 having such a structure includes a plate-fin type heat exchanger provided with a plurality of fins on a pipe and an aerofin type heat exchanger having the adsorbing layer 16 on each surface of the fins.

In the humidity controlling device 10 having the above structure, the air flows between the fins and the heating medium flows through the pipe. The fins are heated by the flow of the heating medium, so that the adsorbing layer 16 provided on each surface of the fins can be heated.

The humidity controlling device 10 having the structure as described above can be produced by using a commercially available plate fin type heat exchanger or aerofin type heat exchanger to form the adsorbing layer 16 on the surfaces of the fins. The adsorbing layer 16 may be formed by the method as described above.

The humidity controlling device 10 may include: a honeycomb structure 11 having an outer peripheral wall 12 and partition walls 15 provided on an inner side of the outer peripheral wall 12, the partition walls 15 defining a plurality of cells 14 each extending from a first end face 13a to a second end face 13b of the honeycomb structure 11 to form a flow path for air; an adsorbing layer 16 containing an adsorbent, the adsorbing layer 16 being provided on a surface of each of the partition walls 15; and a heater provided on an upstream side of the honeycomb structure 11. It should be noted that the structure of the humidity controlling device 10 corresponds to the structure in which the pair of electrodes 17a, 17b and the terminals 18 are removed in FIG. 3A.

In the humidity controlling device 10 having the heating structure as described above, the adsorbing layer 16 provided on each surface of the partition walls 15 can be heated by allowing the air heated by the heater to flow through the cells 14 of the honeycomb structure 11.

The humidity controlling device 10 having the heating structure as described above can be formed from various materials such as metals and ceramics, because the honeycomb structure 11 itself is not required to generate heat by electrical conduction. The honeycomb structure 11 may be made of a material that can be heated by electrical conduction.

The humidity controlling device 10 having the heating structure as described above can be produced according to the method as described above.

### (2. Air Conditioning Duct 20)

The air conditioning duct 20 is a flow path that can allow the air from the vehicle interior or the vehicle exterior to flow therethrough. The upstream side of the air conditioning duct 20 is connected to the vehicle interior or an outside air introduction port. The air conditioning duct 20 allows the air from the vehicle interior or vehicle exterior to flow in, and also allows the air that has passed through the humidity controlling device 10 to flow in the vehicle interior or discharge it to the vehicle exterior. Therefore, the air conditioning duct 20 can have a structure that branches into a first flow path 20a that allows the air to flow into the vehicle interior on the downstream side of the humidity controlling device 10, and a second flow path 20b that allows the air to be discharged to the vehicle exterior.

### (3. Valve 30)

The valve 30 may be configured to switch the flow of the air between the first flow path 20a and the second flow path 20b. The valve 30 can be provided at a branch portion between the first flow path 20a and the second flow path 12b in the air conditioning duct 20.

The valve 30 is not particularly limited as long as it is electrically driven and has the function of switching the flow path, and a solenoid valve, an electric valve, and the like can be used. For example, the valve 30 can a butterfly valve including an opening/closing door supported by a rotating shaft and an actuator such as a motor for rotating the rotating shaft. The actuator can be configured to be controllable by the control unit 50. A flap valve that controls opening and closing by a flap valve or a slide valve that controls opening and closing by movement of a sliding body (valve) may also be used.

### (4. Ventilation Fan 40)

The ventilation fan 40 is a device for allowing the air from the vehicle interior or the vehicle exterior to flow in the humidity controlling device 10, and is provided in the air conditioning duct 20. The position of the ventilation fan 40 is not limited, but it may be on the upstream side of the humidity controlling device 10, for example, as illustrated in FIG. 1 and the like, or on the downstream side of the humidity controlling device 10.

The ventilation fan 40 is electrically connected to the control unit 50 and can control the flow rate of the air by adjusting the rotational speed according to instructions from the control unit 50.

### (5. Power Source 60)

The power source 60 is for applying a voltage to the humidity controlling device 10 (in particular, the pair of electrodes 17a, 17b). The power source 60 is electrically connected to the control unit 50, and adjusts the state of the voltage applied to the pair of electrodes 17a, 17b according to instructions from the control unit 50.

The power source 60 is not particularly limited, and a battery or the like can be used.

### (6. Control Unit 50)

The control unit 50 controls the humidity controlling device 10 and the valve 30. Further, the control unit 50 can also control the ventilation fan 40.

The control unit 50 is electrically connected to the humidity controlling device 10 and the ventilation fan 40 via the power source 60. The control unit 50 can control the power source, thereby adjusting the heating state of the honeycomb structure 11 by controlling a voltage applying state to the pair of electrodes 17a, 17b of the humidity controlling device 10. Further, the control unit 50 can also control the valve 30 so that the air flows through the first flow path 20a or the second flow path 20b. Furthermore, the control unit 50 can adjust the rotational speed of the ventilation fan 40, thereby controlling the flow rate of the air flowing through the air conditioning duct 20.

The control unit 50 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 50 can perform a moisture adsorption mode configured to switch the valve 30 so that the air flows into the first flow path 20a, and a regeneration mode configured to heat the humidity controlling device 10 and switch the valve 30 so that the air flows into the second flow path 20b.

In the moisture adsorption mode, the moisture in the air circulating from the vehicle interior or vehicle exterior is adsorbed, and the air with reduced or removed moisture is returned to the vehicle interior through the first flow path 20a. In the regeneration mode, the moisture adsorbed in the adsorbing layer 16 is desorbed, and then discharged through the second flow path 20b to the vehicle exterior.

From the viewpoint of stably performing the above control, it is desirable that the humidity controlling device 10 be placed at a position close to the vehicle interior. Therefore, from the viewpoint of preventing electric shock and the like, it is preferable that the driving voltage of the humidity controlling device 10 is 60V or less. Since the honeycomb structure 11 used in the humidity controlling device 10 has a low electrical resistance at room temperature, the honeycomb structure 11 can be heated at the low driving voltage. It should be noted that the lower limit of the driving voltage is not particularly limited, but it may preferably be 10 V or more. If the driving voltage is less than 10V, the current during heating the honeycomb structure 11 becomes large, so that the conductor wire should be thick.

### Examples

Hereinafter, the present disclosure will be more specifically described with reference to Examples, but the present disclosure is not limited to these Examples.

### <Production of Humidity Controlling Device>

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.

Shape of cross section and end face of honeycomb structure orthogonal to flow path direction: quadrangular;

Shape of cross section of cells orthogonal to flow path direction: quadrangular;

Thickness of partition walls: 0.100 mm;

Thickness of outer peripheral wall: 0.2 mm;

Cell density: 80 cells/cm²;

Cell pitch: 1.1 mm;

Cross-sectional area of honeycomb structure orthogonal to extending direction of flow path: 12000 mm²;

Length of honeycomb structure in extending direction of flow path: 10 mm;

Volume resistivity of materials comprised of outer peripheral wall and partition wall at 25° C.: 15 Ω·cm; and Curie point of material making up outer peripheral wall and partition wall: 110° C.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The pair of electrodes were formed on both end faces (first end face and second end face) of the resulting honeycomb structure. First, an electrode slurry containing aluminum (electrode material), ethyl cellulose and diethylene glycol monobutyl ether (organic binder) was prepared and applied to the first end face, and the electrode slurry was then dried to form an electrode on the first end face. Using the same electrode slurry, an electrode was formed on the second end face by applying the electrode slurry to the second end face and drying it.

The honeycomb structure with a pair of electrodes was then immersed in a slurry containing zeolite (adsorbent), an organic binder, and water, and the slurry adhering to excess positions (such as the periphery) was removed by blowing and wiping, and then dried at about 550° C. to form an adsorbing layer having a thickness of 150 μm on surfaces of the partition walls and on a surface of the outer peripheral wall facing the cells.

The humidity controlling device obtained as described above was placed in the air conditioning duct to construct the air conditioning system illustrated in FIG. 1. In this air conditioning system, a thermometer was also placed to measure the temperature Ta on the inner surface of the air conditioning duct.

In the air conditioning system, assuming an environment where condensation easily occurs in the air conditioning duct between the humidity controlling device and the valve, the following regeneration mode experiments were conducted and the state of condensation generated in the air conditioning duct was visually evaluated. In the regeneration mode, a voltage of 12 V was applied to the honeycomb structure for 3 minutes.

First, the temperature Ta on the inner surface of the air conditioning duct was measured by the thermometer.

The flow rate of the air flowing into the humidity controlling device, Q [m³/s] was varied as shown in Table 1, while the dew point temperature Tb was calculated using the equation (5). In this case, the amount of moisture released Wd for the humidity controlling device was 0.05 [g/s] and the absolute humidity AHi of the air flowing into the humidity controlling device was 8.2 [g/m³], and the temperature of the air in the air conditioning duct between the humidity controlling device and the valve, Tp, was 60 [° C.].

The results of the above evaluations are shown in Table 1.

The results of the evaluation of the state of the condensation generated are expressed as follows: double circle for no condensation; circle for a slight amount of condensation but no problem; and x for a large amount of condensation.

TABLE 1

| | Temperature Ta | Dew Point | |
|---|---|---|---|
| Flow Rate | [° C.] on Inner | Temper- | |
| of Air Q | Surface of Air | ature Tb | Conden- |
| [m³/s] | Conditioning Duct | [° C.] | sation |
| 0.00017 | 58.7 | 79.9 | X |
| 0.00050 | 56.3 | 56.1 | ◯ |
| 0.00083 | 51.9 | 46.7 | ⊚ |
| 0.00117 | 50.5 | 41.2 | ⊚ |
| 0.00183 | 48.6 | 34.4 | ⊚ |
| 0.00317 | 46.3 | 27.6 | ⊚ |
| 0.00383 | 45.5 | 25.5 | ⊚ |
| 0.00483 | 44.0 | 23.3 | ⊚ |

As shown in Table 1, by controlling the flow rate of the air Q so that the temperature Ta on the inner surface of the air conditioning duct was higher than the dew point temperature Tb, the generation of the condensation could be suppressed. Specifically, the flow rate of the air Q is 0.00050 [m³/s] or more, whereby the condensation can be suppressed, especially the flow rate of the air Q is 0.00083 [m³/s] or more, whereby the generation of the condensation could be stably suppressed.

As can be seen from the above results, according to this disclosure, it is possible to provide a vehicle air conditioning system that can suppress the generation of condensation when executing a regeneration mode of a humidity controlling device and can suppress the intrusion of water droplets into a vehicle interior when executing a moisture adsorption mode of the humidity controlling device.

### DESCRIPTION OF REFERENCE NUMERALS

10 humidity controlling device
11 honeycomb structure
12 outer peripheral wall
13a first end face
13b second end face
14 cell
15 partition wall
16 adsorbing layer
17a, 17b pair of electrodes
18 terminal
20 air conditioning duct
20a first flow path
20b second flow path
30 valve
40 ventilation fan
50 control unit
60 power source

1. A vehicle air conditioning system, comprising:
at least one humidity controlling device configured to adsorb and desorb moisture;
an air conditioning duct having the humidity controlling device provided therein and allowing air from a vehicle interior or a vehicle exterior to flow therethrough, the air conditioning duct having a first flow path for allowing the air to flow into the vehicle interior on a downstream side of the humidity controlling device and a second flow path for discharging the air to the vehicle exterior;
a valve configured to switch the flow of the air between the first flow path and the second flow path; and
a ventilation fan configured to adjust a flow rate of the air flowing through the air conditioning duct; and
a control unit configured to control the humidity controlling device, the valve and the ventilation fan,
wherein, when executing a regeneration mode in which the valve is switched so that the air flows into the second flow path to desorb the moisture from the humidity controlling device, the control unit controls the ventilation fan so that, in a region in the air conditioning duct between the humidity controlling device and the valve, a temperature Ta on an inner surface of the air conditioning duct is higher than a dew point temperature Tb, to adjust a flow rate of the air.

2. The vehicle air conditioning system according to claim 1, further comprising a thermometer for measuring the temperature Ta on the inner surface of the air conditioning duct, and a dew point meter for measuring the dew point temperature Tb.

3. The vehicle air conditioning system according to claim 1, wherein the temperature Ta on the inner surface of the air conditioning duct is calculated by the following equation (1):
$$Ta = Tp - \frac{Tp - Tc}{Hci \times ( \frac{1}{Hco} + \frac{1}{Kg} + \frac{1}{Hci} )} \qquad ( 1 )$$
in which Tp is a temperature of the air in the air conditioning duct between the humidity controlling device and the valve [° C.], Tc is a temperature of the air in the vehicle interior [° C.], Hci is a heat transfer coefficient of the air in the air conditioning duct between the humidity controlling device and the valve [W/m²K], Hco is a heat transfer coefficient of the air outside the air conditioning duct between the humidity controlling device and the valve [W/m²K], and Kg is a heat transfer coefficient of the air conditioning duct [W/m²K].

4. The vehicle air conditioning system according to claim 1, wherein the temperature Ta on the inner surface of the air conditioning duct is calculated by the following equation (2):
$$Ta = Tp - \frac{Tp + 10}{Hci \times ( \frac{1}{Hco} + \frac{1}{Kg} + \frac{1}{Hci} )} \qquad ( 2 )$$
in which Tp is a temperature of the air in the air conditioning duct between the humidity controlling device and the valve [° C.], Hci is a heat transfer coefficient of the air in the air conditioning duct between the humidity controlling device and the valve [W/m²K], Hco is a heat transfer coefficient of the air outside the air conditioning duct between the humidity controlling device and the valve [W/m²K], and Kg is a heat transfer coefficient of the air conditioning duct [W/m²K].

5. The vehicle air conditioning system according to claim 3, wherein the Tp is calculated based on a relationship between the Tp and a flow rate of the air flowing into the humidity controlling device when the regeneration mode is executed, which is determined beforehand.

6. The vehicle air conditioning system according to claim 3, wherein the Tc is measured by a thermometer provided in the vehicle interior.

7. The vehicle air conditioning system according to claim 3, wherein the Hci is calculated by the following equation (3)
$$Hci = 7.1 \times {U}_{A}^{0.78} \qquad ( 3 )$$
in which U_{A} is a flow velocity of the air flowing into the humidity controlling device during the execution of the regeneration mode [m/s].

8. The vehicle air conditioning system according to claim 3, wherein the Hco is calculated by the following equation (4):
$$Hco = 5.57 + 3.94 {U}_{B} \qquad ( 4 )$$
in which U_{B} is a flow velocity of the air to which the air conditioning duct between the humidity controlling device and the valve is exposed [m/s].

9. The vehicle air conditioning system according to claim 1, wherein the dew point temperature Tb is calculated by the following equation (5):
$$Tb = \frac{273.3 \times {log}_{10} \frac{6.1078 \times Q \times 217}{( Wd + Q \times AHi ) \times ( Tp + 273.15 )}}{{log}_{10} [ \frac{( Wd + Q \times AHi ) \times ( Tp + 273.15 )}{6.1078 \times Q \times 217} ] - 7.5} \qquad ( 5 )$$
in which Wd is an amount of moisture released by the humidity controlling device [g/s], Q is a flow rate of the air flowing into the humidity controlling device [m³/s], AHi is an absolute humidity of the air flowing into the humidity controlling device [g/m³], and Tp is a temperature of the air in the air conditioning duct between the humidity controlling device and the valve [° C.].

10. The vehicle air conditioning system according to claim 1, wherein the dew point temperature Tb is calculated by the following equation (6):
$$Tb = \frac{273.3 \times {log}_{10} \frac{6.1078 \times Q \times 217}{( Wd + Q \times 10 ) \times ( Tp + 273.15 )}}{{log}_{10} [ \frac{( Wd + Q \times 10 ) \times ( Tp + 273.15 )}{6.1078 \times Q \times 217} ] - 7.5} \qquad ( 6 )$$
in which Wd is an amount of moisture released by the humidity controlling device [g/s], Q is a flow rate of the air flowing into the humidity controlling device [m³/s], and Tp is a temperature of the air in the air conditioning duct between the humidity controlling device and the valve [° C.].

11. The vehicle air conditioning system according to claim 9, wherein the Wd is calculated based on a relationship between a flow rate and an inflow time of the air flowing into the humidity controlling device, which is determined beforehand.

12. The vehicle air conditioning system according to claim 9, wherein the AHi is measured by a hygrometer provided in the air conditioning duct on an upstream side of the humidity controlling device.

13. The vehicle air conditioning system according to claim 1, wherein the humidity controlling device comprises: an adsorption portion comprising an adsorbent configured to adsorb the moisture at a temperature lower than or equal to a predetermined temperature and desorb the adsorbed moisture when the temperature exceeds the predetermined temperature; and a heating means or a heating structure configured to heat the adsorption portion.

14. The vehicle air conditioning system according to claim 13, wherein the humidity controlling device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer comprising the adsorbent, the adsorbing layer being provided on a surface of each of the partition walls; and
a pair of electrodes provided on the first end face and the second end face of the honeycomb structure, or on the outer peripheral wall parallel to an extending direction of the cells of the honeycomb structure.

15. The vehicle air conditioning system according to claim 14, wherein at least the partition walls of the honeycomb structure are made of a material having a positive temperature coefficient (PTC) property.

16. The vehicle air conditioning system according to claim 13, wherein the humidity controlling device has a flow path for the air and a flow path for a heating medium adjacent to the flow path for the air, and wherein the adsorption portion is provided in the flow path for the air.

17. The vehicle air conditioning system according to claim 13, wherein the humidity controlling device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer comprising the adsorbent, the adsorbing layer being provided on a surface of each of the partition walls; and
heater provided on an upstream side of the honeycomb structure.

18. The vehicle air conditioning system according to claim 13, wherein the adsorbent is configured to adsorb and desrob carbon dioxide and/or volatile components, in addition to the moisture.
